(19) United States
(12) Patent Application Publication
(10) Pub. No.: US 2005/0000088 A1
(43) Pub. Date: Jan. 6, 2005

(54) Method of determining the position of a supporting pin, and device for this

(76) Inventor: Adrianus Johannes Petrus Maria Vermeer, Eindhoven (NL)

Correspondence Address: Philips Electronics North America Corporation;Corporate Patent Counsel, PO Box 3001, Briarcliff Manor, NY, 10510, US

(21) Appl. No.: 10/493,794

(22) PCT Filed: Oct. 24, 2002
(86) PCT No.: PCT/IB02/04489

(30) Foreign Application Priority Data
Nov. 1, 2001 (EP) 01204184.4

(51) Int. Cl. B23P 19/00

(52) U.S. Cl. 29/739; 29/834

(57) ABSTRACT

Method of determining the position of at least one supporting pin for supporting a side (15) of a substrate (14) in a component placement machine. In a first step of the method, the supporting side (15) of the substrate is made at least partly visible. Next at least one frame (25, 26, 27) is positioned opposite said supporting side (15) of the substrate, said frame comprising at least one fastening element for an auxiliary pin (28). Subsequently the auxiliary pin is arranged in the frame in a removable way in a position in which one end of the auxiliary pin makes contact with the supporting side of the substrate. The obtained position is used as the desired position of the supporting pin.

The invention relates to a method of determining the position of at least one supporting pin for a side of a substrate to be supported in a component placement machine.

The invention also relates to a device suitable for implementing such a method.

It is known per se to support a substrate by means of supporting pins in a component placement machine, inter alia for preventing sagging of the substrate during the placement of components on the substrate.

The supporting pins should bear on the side of the substrate to be supported such that on the one hand a sufficient support is obtained, while on the other hand it is prevented that the supporting pins bear on components provided in an earlier phase on the side to be supported.

In a method known per se, a camera is used for observing the side of the substrate to be supported, whereupon the positions of the supporting pins are determined by a computer. Data have also been previously stored in the computer on the positions in which supporting pins can or cannot be placed in the component placement machine.

It is a disadvantage of this method that the determination of the positions of the supporting pins by means of a camera is comparatively complicated. In addition, it cannot be checked whether the supporting pins to be thus placed offer the substrate a sufficient support. For this purpose the supporting pins should first be provided in a component placement machine. Should the support be insufficient, then positions are to be determined for additional supporting pins, which is comparatively time-consuming. Furthermore, the component placement machine cannot be used for the placement of components during testing whether the desired support is offered by the supporting pins.

The invention has for its object to provide a method by which the desired position of at least one supporting pin can be determined in a comparatively simple manner.

According to the invention, this object is achieved in the method according to the invention in that
the substrate is rendered at least partly visible as regards its side to be supported;
at least one frame is provided opposite the side to be supported, which frame is provided with at least one fastening element for an auxiliary pin;
the auxiliary pin is subsequently detachably provided in the frame in a position in which an end of the auxiliary pin bears on the side to be supported;
whereupon the position of the auxiliary pin is used as a desired position for the supporting pin.

A frame may be provided by a user opposite the side of the substrate to be supported at any time and in any location desired. The side to be supported here faces the user. Preferably, the lower side will be turned so as to face upwards.

Then the user may provide at least one auxiliary pin in the frame on the basis of his/her view of the supporting side. A plurality of auxiliary pins will mostly be used in practice. When an auxiliary pin is provided in the frame, the user will notice immediately if he/she trying to provide the auxiliary pin in a location where a component is already present on the side of substrate to be supported. The user will also be able to realize a regular distribution of the auxiliary pins over the substrate in a simple manner.

After the auxiliary pins have been provided, the positions of the auxiliary pins are determined and are used as desired positions for the supporting pins in the component placement machine.

The method according to the invention is comparatively simple and can be implemented by comparatively low-level staff.

An embodiment of the method according to the invention is characterized in that elements are provided opposite the side to be supported so as to be located in positions corresponding to positions of obstacles to supporting pins, which obstacles are present in the component placement machine, before the auxiliary pin is provided in the frame.

It is prevented thereby that auxiliary pins are provided in the frame in locations where obstacles are present in the component placement machine, such as, for example, components of the component placement machine.

A further embodiment of the method according to the invention is characterized in that the frame together with the auxiliary pins and with the substrate is turned over after the placement of the auxiliary pins, after which the support provided by the auxiliary pins is checked in that the substrate is pressed against the auxiliary pins.

It can thus be tested in a comparatively simple manner whether the auxiliary pins offer a sufficient support. If this is not the case, additional auxiliary pins can be provided in the frame until the desired support has been obtained.

It is not until a sufficient support has been obtained that the positions of the auxiliary pins are to be determined, whereupon they may be used as positions for the supporting pins in the component placement machine. It need not be tested anymore in the component placement machine after that whether the substrate is sufficiently supported, because this has already been verified by means of the auxiliary pins.

A yet further embodiment of the method according to the invention is characterized in that the auxiliary pins are positioned together with the frame in the component placement machine, during which the auxiliary pins act as the supporting pins.

The positions of the auxiliary pins are determined implicitly only in this manner, because the desired positions of the auxiliary pins acting as the supporting pins are immediately obtained through the placement of the frame in the component placement machine.

The invention also relates to a device suitable for implementing the method, which device is characterized in that the device is provided with a holder for the substrate and with a frame which is provided with at least one fastening element for an auxiliary pin.

Auxiliary pins can be provided opposite the side of a substrate to be supported in a simple manner by means of such a device, whereupon the positions of these auxiliary pins can be determined.

The invention will be explained in more detail below with reference to the drawings, in which:

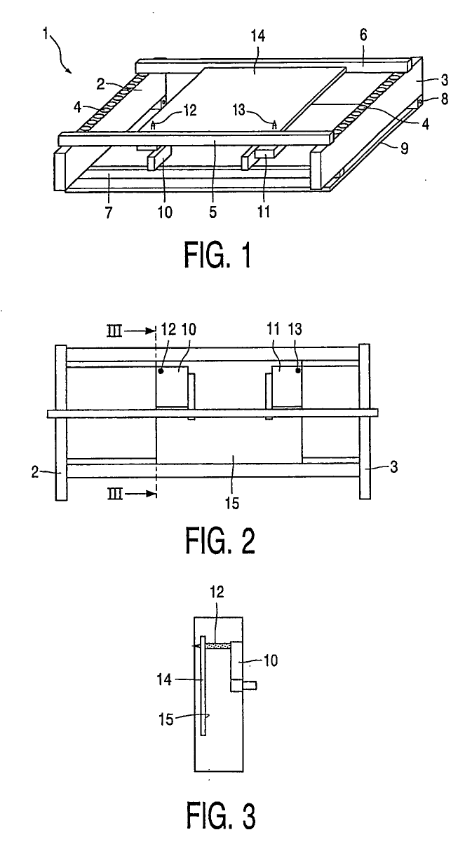

FIG. 1 is a perspective view of a first embodiment of a device according to the invention,

FIG. 2 shows a lower side of the device of FIG. 1,

FIG. 3 is a cross-sectional view taken on the line III-III of the device of FIG. 2,

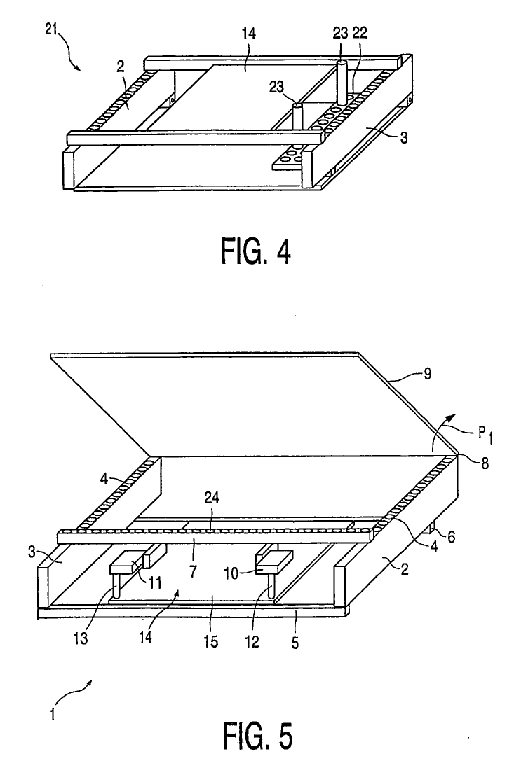

FIG. 4 shows the device of FIG. 1 provided with stop pins,

FIG. 5 shows the device of FIG. 1 after the device has been turned over,

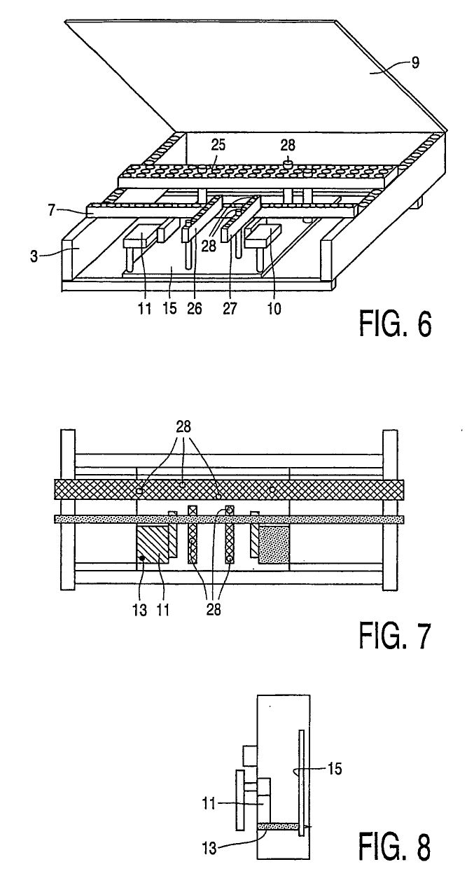

FIGS. 6 to 8 are a perspective view, a plan view, and a cross-section of the device of FIG. 5, respectively, in which a number of auxiliary pins have been provided in the frame,

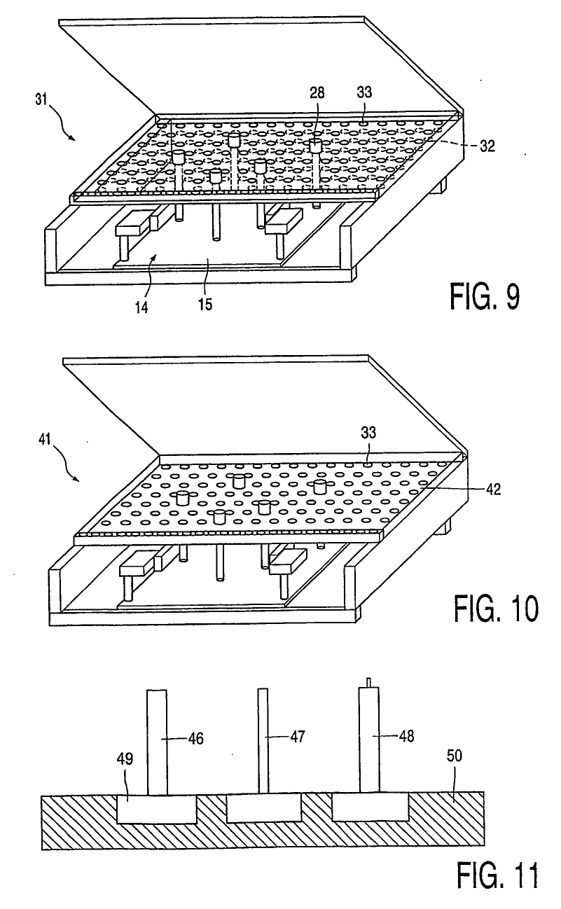

FIG. 9 shows an alternative embodiment of the device of FIG. 5, with the frame being provided with a transparent plate,

FIG. 10 shows an alternative embodiment of the device shown in FIG. 5, with the frame being provided with a steel plate,

FIG. 11 shows various embodiments of auxiliary pins in side elevation,

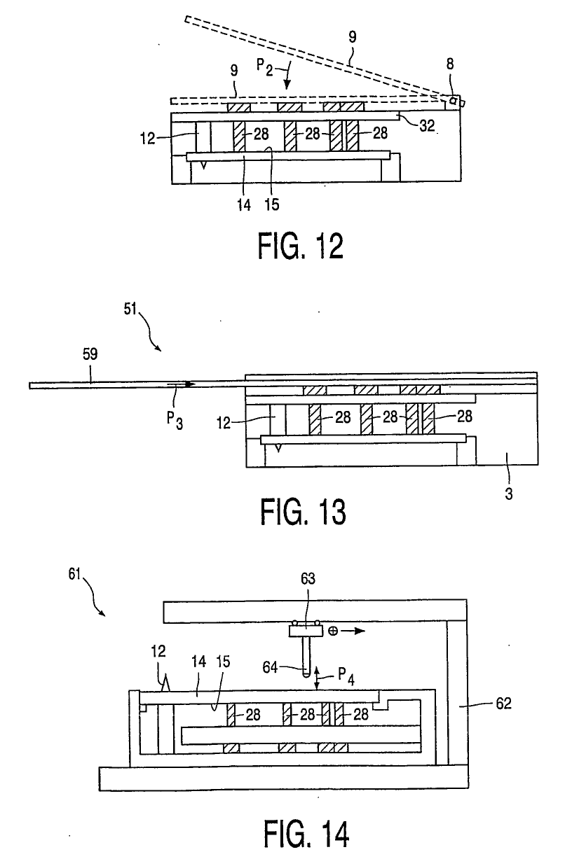

FIG. 12 shows the closing of the device of FIG. 5,

FIG. 13 shows an alternative embodiment for locking the auxiliary pins in the frame,

FIG. 14 is a side elevation of a device for testing the support provided by the auxiliary pins,

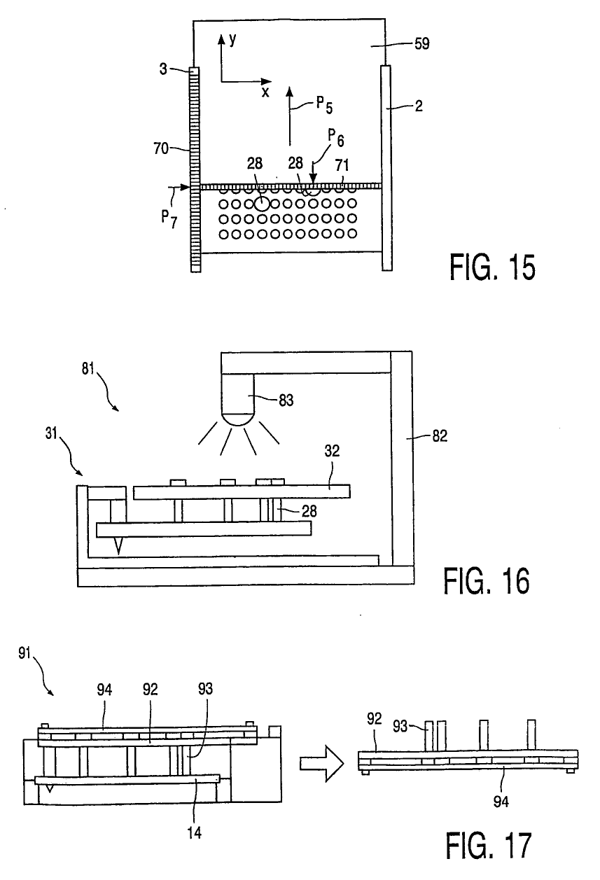

FIG. 15 shows the device of FIG. 13, provided with a measuring device,

FIG. 16 is a side elevation of a device for determining the positions of the auxiliary pins by means of a camera, and

FIG. 17 shows the use of the frame provided with auxiliary pins for a component placement machine.

Corresponding components have been given the same reference numerals in the Figures.

FIGS. 1 to 3 show a device 1 which is provided with two beams 2, 3 which extend parallel to one another and which are provided with a number of regularly spaced holes 4 at the up sides. The beams 2, 3 are interconnected by crossbeams 5, 6, 7 extending transversely to the beams 2, 3. The device is further provided with a lid 9 connected to the beams 2, 3 with hinging possibility about a shaft 8. The crossbeam 7 is provided with two elements 9, 10 which correspond to obstacles present in a component placement machine (not shown). The elements 10, 11 are provided with centering pins 12, 13. In the device shown in FIGS. 1 to 3, a substrate 14 is positioned such that the substrate 14 lies with positioning holes present in the substrate 14 over the positioning pins 12, 13. The beams and crossbeams here form a holder for the substrate. The side of the substrate 14 facing upwards in FIG. 1 forms the side which is yet to be provided with components in the component placement machine. The side of the substrate 14 not visible in FIG. 1 forms the side to be supported in the component placement machine. This side 15 to be supported is visible in FIGS. 2 and 3.

FIG. 4 shows an alternative embodiment of a device 21 according to the invention which is provided with an element 22 on which stop pins 23 for the substrate are fastened. The element 22 and the stop pins 23 correspond to an object present in the component placement machine, to which object stop pins are fastened.

FIG. 5 shows the device 1 of FIG. 1, the side facing upwards in FIG. 1 now facing downwards. To prevent the substrate 14 from dropping from the device 1, the substrate 14 is locked previous to turning over in the device 1. The substrate 14 is locked in the device 1 between the crossbeam 5 fixedly connected to the device 1 and the crossbeam 6 which can be detachably clamped in the beams 2, 3.

After the device 1 has been turned over, the lid 9 is pivoted about the shaft 8 in the direction indicated by arrow P1, so that the side 15 of the substrate 14 to be supported becomes accessible. As is visible in FIG. 5, the beams 2, 3 are also provided with holes 4 at the side visible now. As is also visible in FIG. 5, the crossbeam 7 is also provided with holes 24.

FIG. 6 shows the device of FIG. 5, where a frame built up from strips 25, 26, 27 is detachably fastened to the beams 2, 3 and the crossbeam 7, respectively.

The fastening of the strips 25, 26, 27 to the beams 2, 3 and the crossbeam 7 may be effected, for example, by means of pegs which are inserted through the strips 25, 26, 27 into the holes 4, 24. Alternative, preferably detachable fastening means are obviously also possible.

The strips 25, 26, 27 are provided with a, preferably regular, pattern of holes through when auxiliary pins 28 can be passed. A user 28 pushes said pins through the strips 25, 27 in those locations where the user sees no components placed on the side 15 to be supported. In addition, the user should ensure that the auxiliary pins 28 are regularly distributed over the side 15 to be supported.

The elements 10, 11 prevent the user from placing auxiliary pins in positions which will not be accessible to supporting pins subsequently in the component placement machine.

FIG. 9 shows an alternative embodiment of a device 31 according to the invention in which, instead of strips 25 to 27, a transparent, for example synthetic resin plate 32 is used, in which holes 33 are provided. Auxiliary pins 28 can be passed through the holes 33, during which the transparent plate safeguards a substantially unhampered view of the side 15 of the substrate 14 to be supported.

FIG. 10 shows a further embodiment 41 according to the invention, where the frame is formed by a sturdy, robust metal plate 42 provided with holes 43.

FIG. 11 shows a holder 45 in which three different auxiliary pins 46, 47, 48 are located. The auxiliary pins 46 to 48 each have a head 49 which will bear on the frame.

The auxiliary pin 46 has a comparatively great diameter so as to support the substrate over a comparatively large surface area. The auxiliary pin 47 has a comparatively small diameter which is suitable in particular for supporting the substrate between two components present on the substrate.

The auxiliary pin 48 is provided with a comparatively thin needle of comparatively small diameter.

FIG. 12 shows the device of FIG. 9, where the lid 9 is pivoted from the open position in the direction indicated by arrow P2 into the closed position referenced 9′. The lid 9 is closed the moment the user has provided a number of supporting pins 28 which he/she deems sufficient.

FIG. 13 shows an alternative embodiment of a device 51 according to the invention in which the lid 59 can be shifted in and opposed to a direction indicated by arrow P3, i.e. a direction parallel to the beams 2, 3, instead of the lid 9 hinging about a shaft 8.

FIG. 14 shows a device 61 which is provided with a C-shaped portal 62 in which a measuring ahead 63 displaceable in a horizontal plane is positioned. The measuring head 63 is further provided with a measuring probe 64 which is displaceable in a vertical direction indicated by arrow P4. After the lid 9, 59 has been closed, the relevant device including the frame, the auxiliary pins, and the substrate is turned over such that the substrate 14 lies with its side 15 to be supported on the auxiliary pins 28.

The measuring probe 64 subsequently presses on the substrate 14 in a number of locations, preferably in between the auxiliary pins 28, with a predetermined force, and the displacement of the substrate 14 in vertical direction is measured. If this displacement is greater than desired, additional auxiliary pins 28 will have to be provided in the manner described above. Then the support provided by the auxiliary pins 28 can be tested again by means of the device 61.

FIG. 15 shows the device 51 of FIG. 13, in which the beam 3 and the lid 59 are provided with rulers 70, 71. The positions of all auxiliary pins 28 can be determined in a simple manner through displacement of the lid 59 in the direction indicated by arrow P5. For this purpose, the lid 59 is stopped each time at the center of an auxiliary pin 28. The X- and Y-positions of the auxiliary pin 28 can then be read on the rulers 71 and 70 at the arrows P6 and P7, respectively. Preferably, the rulers 70, 71 are provided with graduations which directly correspond to system of coordinates in a component placement machine. If this is the case, supporting pins can be provided directly in these positions in the component placement machine. The provision of supporting pins in a component placement machine is known per se and will accordingly not be explained in any detail.

FIG. 16 shows a device 81 which is provided with a C-shaped portal 82 and a camera 83 fastened thereto. The positions of the auxiliary pins 28 with respect to the portal 82 and/or the frame 32 and/or the device 31 can be determined by means of the camera 83. The positions determined by the camera 83 should then be converted into positions for the supporting pins in the component placement machine.

FIG. 17 shows a device 91 in which a frame 92 is provided with pins 93 which are detachably fixed relative to the frame 92 by means of a lid 94.

After the desired support of the substrate 14 by the pins 93 has been tested by means of a device, for example a device as shown in FIG. 14, or manually, the fame 92, the auxiliary pins 93, and the plate 94 are jointly transferred to a component placement machine (see the right-hand portion of FIG. 17), where the auxiliary pins, 93 will act as supporting pins.

1. A method of determining the position of at least one supporting pin for a side of a substrate to be supported in a component placement machine, characterized in that
the substrate is rendered at least partly visible as regards its side to be supported;
at least one frame is provided opposite the side to be supported, which frame is provided with at least one fastening element for an auxiliary pin;
the auxiliary pin is subsequently detachably provided in the frame in a position in which an end of the auxiliary pin bears on the side to be supported;
whereupon the position of the auxiliary pin is used as a desired position for the supporting pin.

2. A method as claimed in claim 1, characterized in that the substrate faces upwards with its side to be supported at the moment when the auxiliary pin is provided.

3. A method as claimed in claim 1, characterized in that elements are provided opposite the side to be supported so as to be located in positions corresponding to positions of obstacles to supporting pins, which obstacles are present in the component placement machine, before the auxiliary pin is provided in the frame.

4. A method as claimed in claim 1, characterized in that the frame together with the auxiliary pins and with the substrate is turned over after the placement of the auxiliary pins, after which the support provided by the auxiliary pins is checked in that the substrate is pressed against the auxiliary pins.

5. A method as claimed in claim 1, characterized in that the auxiliary pins together with the frame are positioned in the component placement machine, during which the auxiliary pins act as the supporting pins.

6. A method as claimed in claim 1, characterized in that the positions of the auxiliary pins relative to the frame are determined.

7. A method as claimed in claim 1, characterized in that the positions of the auxiliary pins are determined by means of a camera.

8. A device suitable for implementing the method as claimed in claim 1, characterized in that the device is provided with a holder for the substrate and with a frame which is provided with at least one fastening element for an auxiliary pin.

9. A device as claimed in claim 8, characterized in that the device is provided with elements which can be positioned in positions relative to the frame for blocking the provision of auxiliary pins in these positions.

10. A device as claimed in claim 8, characterized in that the frame is provided with a measuring device for determining the positions of the auxiliary pins relative to the frame.

11. A device as claimed in claim 8, characterized in that the device is provided with means for detachably locking the auxiliary pins relative to the frame.

12. A device as claimed in claim 11, characterized in that said means comprise a lid.

13. A device as claimed in claim 12, characterized in that the lid can be translated with respect to the frame.

14. A device as claimed in claim 12, characterized in that the lid is hinged to the frame.

15. A device as claimed in claim 8, characterized in that the frame together with the auxiliary pins can be positioned in a component placement machine.

16. A device as claimed in claim 8, characterized in that the frame is provided with at least one strip which can be detachably coupled to the holder.

17. A device as claimed in claim 8, characterized in that the frame is provided with a transparent plate comprising a pattern of holes.

18. A device as claimed in claim 8, characterized in that the frame is provided with a steel plate comprising a pattern of holes.
